(19) United States
(12) Patent Application Publication
(10) Pub. No.: US 2012/0255773 A1
(43) Pub. Date: Oct. 11, 2012

(54) BREAKOUT BOX

(76) Inventor: Keith Marshall, Canton, GA (US)

(21) Appl. No.: 13/081,269

(22) Filed: Apr. 6, 2011

(51) Int. Cl. H02G 5/00; H01B 5/02

(52) U.S. Cl. 174/99 B; 174/133 B

(57) ABSTRACT

Aspects relate to structures for providing connections between electronic components, such as signaling devices and power sources utilized in the provisioning of telecommunication services. Further aspects relate to a bus bar and novel methods for utilizing bus bars. In one embodiment, a bus bar may be vertically positionable within a breakout box. The bus bar may be substantially parallel with a back of the structure such that an upper end of the bus bar is positioned above a lower end. Structures and bus bar may be configured to permit a cable to traverse above a first orifice of the first plurality of orifices and bend along a bending radius to traverse in a downward vertical direction to place the cable in direct operative connection with a first orifice of the bus bar. Further aspects relate to arrangement of components with structures.

### BACKGROUND

Personal communication devices have rapidly advanced from basic alpha-numeric pagers to elaborate web-enabled multimedia computers. This rapid advancement has provided numerous benefits to society. However, it has required several modifications to existing infrastructures. In this regard, each new technology requires technicians to properly disconnect and remove older equipment as well as safely install newer equipment. Regular wear and tear on existing equipment also requires the repair and replacement of existing equipment.

Replacing or upgrading electronic components for modern communication and content delivery systems is often an arduous task due to a multitude of different components installed by various technicians using a myriad of installation layouts. First, different equipment manufacturers may offer similar equipment with different dimensions and connections. Second, technicians often do not utilize any guidelines as to specific locations and wiring tables when connecting the various signaling and powering components. This is especially true when wiring or repairing components in breakout boxes, such as often utilized in the telecommunications industry.

Specific and limited usage of bus bars attempt to permit installers to connect electronic components to different locations on the bar. For example, in the telecommunications industry, a breakout box may include a horizontally positioned bus bar that is often located proximate to the bottom, such as within the bottom 20% of the box. Installers and technicians could usually secure some signaling cables to the bus bar. Unfortunately, however, given the size and bending radius of larger diameter cables, such as power cables, many cables cannot be directly affixed to the bus bar. Therefore, patch cables became the required solution to indirectly connect larger diameter cabling, such as power cables and larger signaling cables.

Because multiple breakout boxes and other collections of electronic components are often repaired or upgraded by different individuals or even entities, a technician has little indication whether the previous technician properly connected the components. Accordingly, the technician must inspect various components and locations within the breakout box that is often filled with a myriad of wires and components to determine the location of specific connections and components. This further increases the time each technician spends repairing or upgrading each box and introduces potential for human error. Further, various individuals may utilize different gauge components or color markings, leading to confusion for the next technician or installer who must later repair or install components. This may result in a less-safe working environment for the technicians/installers, premature equipment malfunctioning, loss or degradation of services to the consumer, and increased expenditure for the organization(s) providing the services.

What is needed, therefore, are systems and methods that improve upon conventional devices and processes.

### SUMMARY

The following presents a general summary of aspects of the invention in order to provide a basic understanding of the invention and various features of it. This summary is not intended to limit the scope of the invention in any way, but it simply provides a general overview and context for the more detailed description that follows.

Aspects of this disclosure relate to various structures and use of those structures in accordance with different embodiments of the invention. In one embodiment, a structure may be utilized for providing connections between a plurality of electronic components, such as for example, signaling devices and power sources utilized in the provisioning of telecommunication services. The structure may include a housing for enclosing the devices. In one embodiment, a structure has a top and a bottom as well as two or more sides. In one embodiment, two or more sides may be vertically positioned between the top and the bottom to create an encasement for containing the devices.

Further aspects of this disclosure relate to a bus bar and novel methods for utilizing bus bars. In one embodiment, a substantially planar bus bar may be configured to be vertically positionable within a structure, such as between the top and the bottom of a breakout box. In one such embodiment, the bus bar may be substantially parallel with a back of the structure such that an upper end of the bus bar is positioned above a lower end of the bus bar. In certain embodiments, the bus bar may have several similar or identical voids or orifices located on the upper end. The bus bar may also have additional groups of similar or identical voids that are different than the voids in the other group(s). In one embodiment, a second group of voids may be located on the lower end of the bus bar. The second group of voids may be larger in size than the first group of voids. In one embodiment, the voids are substantially circular. Additional groups of voids may be utilized in accordance with various embodiments and may be positioned throughout the bus bar.

Further embodiments may be configured to permit the reception of at least one cable along an upward vertical direction. For example, the cable may be a power cable having about a 0.75 inch diameter. The cable may be a suppressor cable. In one embodiment, the structure and bus bar are configured to permit the cable to traverse above a first orifice of the first plurality of orifices and bend along a bending radius to traverse in a downward vertical direction to place the cable in direct operative connection with the first orifice of the bus bar.

Further embodiments relate to non-conductive surfaces, including novel arrangements of such surfaces. Certain arrangements of non-conductive surfaces and/or components thereon may provide benefits over existing structures and layouts. In one embodiment, a first substantially planar non-conductive surface may be securable to a side or back of the structure, thereby being substantially parallel to a corresponding portion of the respective side of the housing and substantially perpendicular to the back. Two or more surfaces may be positioned to be about perpendicular with respect with each other. In certain embodiments, a non-conductive surface may include a mounting mechanism configured to mount the bus bar. One or more surfaces may be wood, rubber, plastic, or combinations thereof.

Further aspects of this disclosure relate to novel bus bars. In one embodiment, the bus bar may be a planar surface having a first end and a second end providing a length of about 18 inches. In one embodiment, the first end may have a first group of substantially circular voids having a diameter of about 0.75 inches. In another embodiment, the second end of the bus bar may include a second group and/or a third group of substantially circular voids or orifices; in which the diameter of the second and third plurality of orifices is less than 0.5 inches. In one embodiment, the diameter of the second plurality of orifices is about ⅜ inches. In another embodiment, the diameter of the third plurality of orifices is about 0.25 inches. Yet in other embodiments, the first end of the bus bar may be devoid of any second or third groups of orifices. In further embodiments, the location of at least a portion of the first group of orifices may be positioned within about an inch of a location furthest from the second end.

### BRIEF DESCRIPTION OF THE DRAWINGS

A more complete understanding of the present invention and certain advantages thereof may be acquired by referring to the following detailed description in consideration with the accompanying drawings, in which:

FIG. 1 shows an illustrative communication network through which various inventive principles may be practiced;

FIG. 2 shows an illustrative structure in accordance with an exemplary embodiment of the invention. Specifically, FIG. 2A shows a frontal view of the exemplary structure and FIG. 2B shows a top view of the exemplary structure;

FIG. 3 shows an illustrative bus bar in accordance with one embodiment of the invention;

FIG. 4 shows illustrative surfaces having a configuration in accordance with one embodiment of the invention; and,

FIG. 5 shows additional illustrative surfaces having a configuration in accordance with further embodiments of the invention.

### DETAILED DESCRIPTION

In general, as described above, aspects of this invention relate to systems and methods for arranging and configuring connections between multiple components, such as communication components in a breakout box. Specific examples of the invention are described in more detail below. The reader should understand that these specific examples are set forth merely to illustrate examples of the invention, and they should not be construed as limiting the invention.

In the following description of various example structures in accordance with the invention, reference is made to the accompanying drawings, which form a part hereof, and in which are shown by way of illustration various example structures, electronic connections, bus bars, and/or arrangements of components in accordance with the invention. Additionally, it is to be understood that other specific arrangements of parts and structures may be utilized and structural and functional modifications may be made without departing from the scope of the present invention. Also, while the terms “top,” “bottom,” “front,” “back,” “rear,” “right,” “left,” and the like may be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of this invention unless otherwise required by the claims.

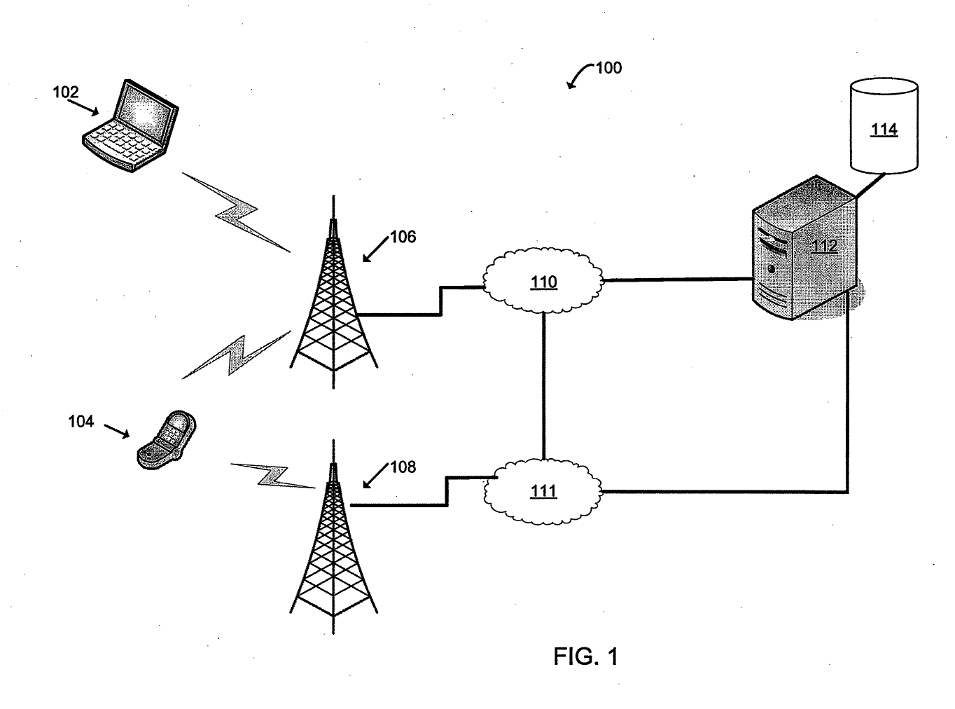

FIG. 1 illustrates an example communication network through which various inventive principles may be practiced. A number of computers and devices, including mobile communication devices 102, 104, may communicate through communication network 100. In certain embodiments, mobile communication devices 102, 104 may comprise a mobile phone, a personal digital assistant (PDA) or mobile computer, a personal computer (PC) or combinations thereof.

In certain embodiments, network 100 may include one or more broadcast transceivers, such as transceivers 106, 108. Transceivers 106, 108 may communicate with one another and with other devices through network 100, such as devices 102 and/or 104. In this regard, transceivers 106, 108 may be configured to transmit and receive data through one or more communication protocols. For example, transceivers 106, 108 may communicate through short or medium range wireless communication connection, e.g., ultra wideband (UWB), wireless local area network (WLAN) according to one or more versions of Institute of Electrical and Electronics Engineers (IEEE) standard no. 802.11, or a high-speed wireless data network such as Evolution-Data Optimized (EV-DO) networks, Universal Mobile Telecommunications System (UMTS) networks, Long Term Evolution (LTE) networks, Enhanced Data rates for GSM Evolution (EDGE) networks, or WiMax or 4^{th} generation (4G) networks.

Transceiver 106 and/or 108 may be operatively connected to a fixed network structure. For example, communication network 100 may include one or more component networks, such as networks 110 and/or 111. These sub-networks may be private or public packet-switched networks, e.g., the public Internet and/or private networks utilizing Internet Protocol (IP), one or more private or public circuit-switched networks, e.g., a public switched telephone network. Thus, devices 102, 104 may be configurable to use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

Communication through network system 100 is not limited to the illustrated devices and may include additional mobile or fixed devices. In one example, mobile devices 102, 104 may include client software that is configured to coordinate the transmission and reception of information to and from a content provider/server 112. Server 112 may include or be operatively connected to a computer-readable medium, such as computer-readable medium 114 and a processor (not shown). Computer-readable medium 102 may comprise one or more computer-executable instructions which may be executed by a processor, either locally on sever 102 or remotely. The computer-executable instructions may include one or more applications. In one arrangement, client software on devices 102 and/or 104 may include application or server specific protocols for requesting and receiving content from content server 112 to be transmitted through transceivers 106, 108. For example, client software may comprise a Web browser or mobile variants thereof and content provider/server 112 may comprise a web server.

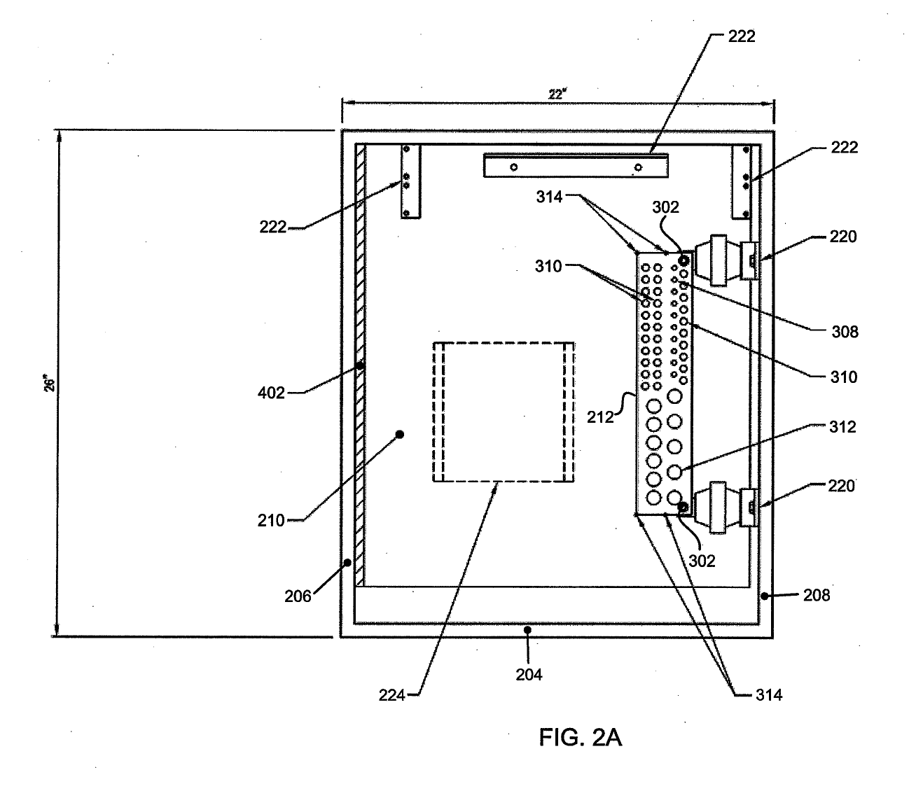

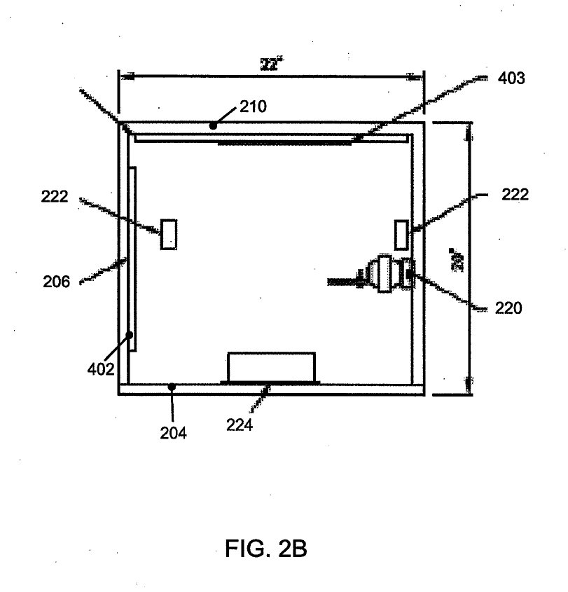

As described above, there are many different communication protocols, each of which may require distinct hardware components. In certain implementations, various structures may be utilized to house or otherwise include components required for the transmission/reception of data. For example, portions of a mobile telecommunications system may comprise one or more structures, such as breakout boxes, configured to receive power and signaling sources and may further include communication devices, such as modems for use on a communication network. FIG. 2 shows an illustrative structure 200 that may be utilized in accordance with one or more embodiments of the invention. First looking to FIG. 2A, a frontal view of structure 200 is shown. Structure 200 may include a top 202 and a bottom 204. Top 202 and bottom 204 may be oriented in a substantially parallel fashion, such as each extends along a horizontal direction. As shown in FIG. 2A, top 202 and bottom 204 may be about 2 inches wide (represented by the horizontal direction in the figure). In other embodiments, top 202 and bottom 204 may be about 18 inches to about 22 inches wide. These are merely exemplary dimensions, and the size and shape of top 202, bottom 204, and/or other portions of structure 202 may vary without departing from the scope of this disclosure.

Structure 200 may further include a plurality of sides that extend a vertical distance between portions of top 202 and bottom 204. In certain embodiments, one or more sides may be a vertical wall extending the entire distance from the top 202 to the bottom 204. For example, as best seen in FIG. 2B, sides 206, 208 of structure 200 include two substantially planar sides that entirely extend between top 202 and bottom 204. In one embodiment, sides 206 and 208 are about 26 inches in height (shown as the vertical direction in FIG. 2A).

Those skilled in the art with the benefit of this disclosure will readily understand that although top 202, bottom 204, and sides 206, 208 are portrayed as substantially flat and uniformly extending the entire distance from the front 209 and the back 210 (the front and the back are best shown in FIG. 2B) of the structure 200, that is not a requirement. For example, any of these (or other components) may consist only of a single bar or tube for structural support. Yet in other embodiments, one or more components may comprise voids, protrusions, or a combination thereof, and traverse a plurality of axes. In still yet other embodiments, top 202, bottom 204 and/or sides 206, 208 may be devoid of any structural components, and as such, consist solely of an opening. For example, as seen best in FIG. 2A, front 209 is shown without any structural components. Those skilled in the art, however, will appreciate that certain embodiments may include a door, or other movable structure that may pivot, move, or be removable to access the inside of the structure 200 (see, e.g., FIG. 2B). In this regard, any of the components described above may be removed or otherwise undergo movement to permit access to the interior portion of structure 200.

The above referenced components, as well as other structural components of an exemplary structure, such as structure 200, may comprise a conductive material, such as metal, including for example, steel, aluminum, copper, iron, brass, titanium, as well as derivatives and combinations thereof.

Structure 200 may be configured to receive and vertically retain a bus bar, such as bus bar 212. As depicted, bus bar 212 may be a substantially rectangular planar object that may be made of any conductive material, such as sheet metal.

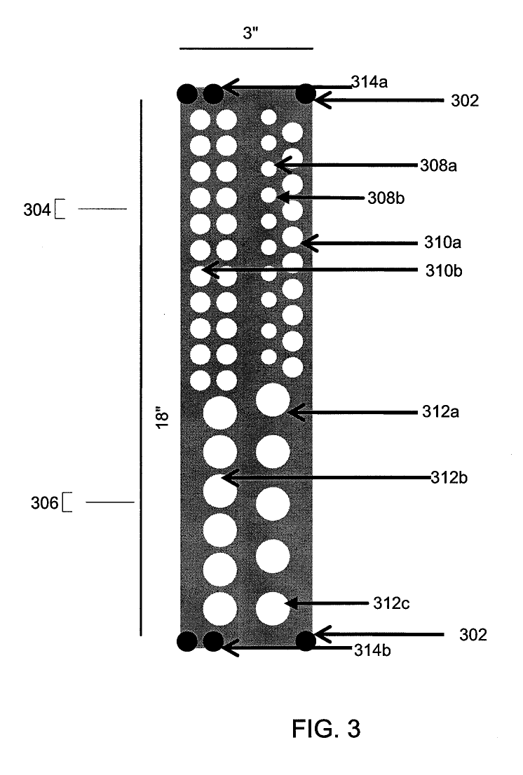

FIG. 3 shows exemplary bus bar 300 that may be utilized in conjunction with various embodiments of the invention. For example, in one embodiment, bus bar 300 may be substantially identical to bus bar 212 shown in FIGS. 2A and 2B. Looking to FIG. 3, bus bar 300 is substantially planar. Bus bar 300 may be shaped and sized to be vertically positioned within a structure, such as structure 200. For example, bus bar 300 may be about 18 inches in height, less than about 0.5 inch in depth, and about 0.20 to 0.50 inches in width.

Bus bar 300 may comprise one or more mounting locations 302 for mounting bus bar 300 to an object, such as for example, structure 200 shown in FIG. 2 or a portion thereof. One or more of mounting locations 302 may include an orifice or void configured to receive a fastening device. Exemplary fastening devices may include, but are not limited to: screws, bolts, nails, clips, ties, or combinations thereof. In one embodiment, one or more of the mounting locations 302 may comprise or be configured to comprise an insulating material, such as for example, rubber, plastic or cork. As shown in FIG. 3, bus bar 300 includes four (4) mounting locations, each of which are proximately located near a corner of the bus bar 300. The location and quantity of mounting locations 302 is shown for illustrative purposes only and those skilled in the art with the benefit of this disclosure will readily understand that other configurations may be utilized to realize the benefit of novel features disclosed herein without departing from the scope of this disclosure, including the claims appended hereto.

In one embodiment, the bus bar 300 is configured to be vertically mountable within a structure, such as structure 200. For example, returning briefly to FIGS. 2A and 2B, bus bar 212 is shown positioned between top 202 and bottom 204 in which it is also substantially parallel with the back 210 of the structure 200. Bus bar 212 is reproduced as bus bar 300 in FIG. 3. Similar reference numerals are also provided on bus bar 212 on FIG. 2A where space provides.

Looking to FIG. 3, bus bar 300 is also shown in a vertical orientation, such that an upper end 304 of the bus bar is positioned above a lower end 306 of the bus bar 300.

Illustrative bus bar 300 is also depicted with a first plurality of orifices 308 (see e.g., orifices 308a, 308b) located on the upper end 304, which are shown as being circular in shape. In one embodiment, the plurality of orifices 308 may be about 0.25 inches in diameter. Unless otherwise stated, there is no requirement that any of the orifices disclosed herein be circular, although in certain embodiments, circular-shaped orifices may be desired. In other embodiments, orifices 308 (as well as orifices 310 and 312, which are discussed below) may be irregular shaped, such as oval and in further embodiments, orifices may be polygonal, including resembling one or more different regular polygons.

As further seen in the embodiment depicted in FIG. 3, first plurality of orifices 308 may be differentiated from a second plurality of orifices 310 (see, e.g. 310a, 310b) in accordance with the size of the diameter of the orifices. For example, orifices 310 are also depicted as being positioned on the upper end 304 of bus bar 300 and being circular in nature. In one embodiment, the second plurality of orifices may be about ⅜ inches in diameter. Thus, the area of an orifice within plurality 308 may be different than the area of an orifice within plurality 310. In other embodiments, the perimeter, cross-sectional width, and/or area may be utilized to distinguish between different groups of orifices. The shape and size of the orifices disclosed herein, such as for example, orifices 308-312, may be a function of the intended usage of the bus bar. For example, they may be utilized to assist the arrangement and/or connection of electronic components within a structure, such as for example, structure 200. In one embodiment, one or more different orifices disclosed herein may be utilized for connecting various telecommunications components in a breakout box.

Similarly, a third plurality of orifices 312 may be differentiated from the first and second plurality of orifices 308, 310 by the diameter or perimeter of the orifices in that group. For example, in one embodiment, orifices 312 may be circular and be about 0.75 inches in diameter. As seen, the third plurality of orifices 312 are positioned, such that when bus bar 300 is mounted in a vertical position as depicted in FIG. 2, orifices 312 are positioned on the lower end 306 of bus bar 300.

Before proceeding further, applicants wish to clarify certain aspects of the orifices 308-312 disclosed herein. First, there is no requirement that 3 groups of differently sized orifices be provided. In certain embodiments, 4 or more may be utilized. Yet in other embodiments, only 2 groups may be present. In this regard, the only requirement in accordance with one embodiment is that at least two differently sized orifices are provided and when bus bar 300 is positioned in a vertical arrangement as depicted in FIG. 2, then an orifice with the largest area is positioned on the lower end 306. In this regard, there is no exclusion, unless otherwise claimed, that a differently sized orifice, such as from orifices 308, 310 cannot be positioned on the lower end 306 of bus bar 300. In certain embodiments, however, at least one orifice having a diameter, perimeter, or area that is different that the largest orifice is located lower on the lower end 306 of bus bar 300. In yet other embodiments, however, bus bar 300 may be configured such that only orifices having the largest area can be located on the lower end 306. For example, as shown in FIG. 3, only orifices from plurality 312 are positioned on the lower end 306.

Second, there is no requirement of a specified quantity of orifices, either within each similarly-sized group or total among a plurality of groups (such as, for example, pluralities 308-312) to be located on bus bar 300 or a portion thereof (such as upper end 304 and lower end 306). In certain embodiments, however, the location and/or quantity of orifices 308-312 depicted in FIG. 3 may be desired and provide novel arrangements not previously considered or suggest by the prior art. Bus bar 300 may include one or more ground connecting points, such as points 314a and/or 314b.

Returning to exemplary structure 200 of FIGS. 2A and 2B, novel arrangements may position bus bar 212 (which may be substantially identical or similar to bus bar 300) within structure 200, such that bus bar 212 is vertically positioned between top 204 and bottom 204 and substantially parallel with the back 210 such that the upper end (see 304 of FIG. 3) of bus bar 212 is positioned above lower end (see 306 of FIG. 3) of bus bar 300.

In one embodiment, bus bar 212, 300 may be mounted to one of the sides 206, 208 of the structure 200. For example, in embodiment, one or more mounting locations (302 of FIG. 3) may be utilized to secure bus bar 212 to side 208. In one such embodiment, a cherry insulator and corresponding bracket (see element 220), which are well known to those of ordinary skill in the art, may be used to secure the bus bar 212 to either side 206, 208. In other embodiments, however, bus bar 300 may be secured to back 210, top 202 and/or bottom 204. In one embodiment, bus bar 212 is vertically positioned such that its closest edge of bus bar 212 is about 14 to 17 inches from one of the sides 206, 208. Yet in other embodiments, the distance of vertical bus bar's 212 closest edge from the side in which it is mounted is about 15% of the total distance separating the two parallel sides 206, 208. In other embodiment, the bottom of vertically arranged bus bar 212 may be positioned to be about 3 to 6 inches from the bottom 204 of structure 200. In yet other embodiments, the distance from the lowest point of the vertically-positioned bus bar 212 from the bottom 204 is about 15% of the distance separating the top 202 and bottom 204. As seen in FIG. 2B, bus bar 212 is not required to be positioned proximate the rear of a structure, such as back 210 of structure 200. In one embodiment, bus bar 212 may be vertically positioned such that the distance between back 210 of structure 200 and bus bar 212 is about 45-65% of the distance between the back 210 and front 209 of structure 200. In another embodiment, this distance may be about 50%. In another embodiment, bus bar 212 may be vertically positioned such that the distance between back 210 of structure 200 and bus bar 212 is about 9 to about 11 inches.

Structure 200 may further be configured such that a bottom portion, such as bottom 204 may be configurable to receive at least one power cable travelling along an upward vertical direction. In one embodiment, bottom 204 may be configured to have two orifices, wherein the first orifice is configured to receive cables, such as power cables, from a first conduit and the second orifice is configured to receive different cables, such as signaling cables utilized in the telecommunications industry, from a second conduit. Structure 200 may be configured such that a cable may be positioned to traverse above a first orifice of the third plurality of orifices 312 of bus bar 300 (such as 312c) and bend along a bending radius to traverse a downward direction to position the cable in direct operative connection with an orifice, such as first orifice 312a of the vertically-positioned bus bar 300, located on the lower end 306 of bus bar 300. The exact location of the first orifice is not important, so long as in one embodiment, the cable is permitted to be secured to an orifice that a) has or is among a group having the largest area (see, e.g., group 312 compared with groups 308 and 310) on bus bar 300, and b) is located on the lower end 204 of the bus bar 300. In one embodiment, the cable may be a power cable and connects to an orifice on bus bar 300 that is about 0.75 inches in diameter. In one embodiment, the cable may traverse upward at least about 25% of the distance between top 202 and bottom 204 of structure. In yet another embodiment, the cable may traverse upward at least about 50% of the distance between top 202 and bottom 204 of structure. In other embodiments, the cable may traverse upward at least 25% of the vertical distance of the bus bar 300 when vertically positioned on structure 200. In other embodiments, the cable may traverse upward at least 50% of the vertical distance of the bus bar 300 when vertically positioned on structure 200.

In certain embodiments, the vertical arrangement of bus bar within structure 200 and the securement of a power cable to the lower end 306 of bus bar 300 may permit the power cable to be in a travelling in a vertical direction. The vertical direction may have a horizontal component, such that the cable may be substantially diagonally positioned. In certain embodiments, the cable may be configured to be in a position that is more vertical in nature than a cable carrying signal information. Thus, by utilizing certain novel arrangements and configurations disclosed herein, installers and retrofitters of telecommunications equipment or other electronic devices may be in a more perpendicular arrangement than previously possible.

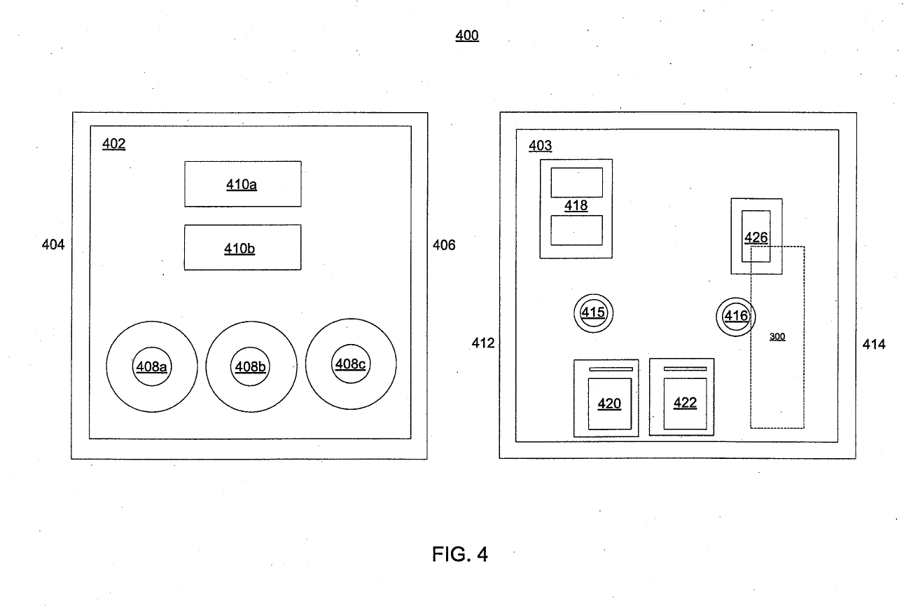

As discussed above, structure 200 may be a breakout box for a communications network, such as network 100. Structure 200, therefore, may include one or more additional components for connecting (such as through bus bar 300) electronic components, including power and/or signaling components. In this regard, further aspects of certain embodiments of the invention relate to improved arrangements of communication components on two or more surfaces, such as sides 206, 208, back 210, and/or non-conductive surfaces, such as the surfaces discussed in relation to FIG. 4 below.

FIG. 4 shows an illustrative arrangement 400 of components that may be used on two surfaces. In one embodiment, surfaces 402, 403 may comprise non-conductive materials vertically positioned within structure 200. For example, illustrative surface 402 may be positioned on side 206 such that the left most edge 404 of surface 402 is proximate to the front 209 of structure 200 and the right most edge 406 of surface 402 is proximate to the rear portion of structure 200. In one embodiment, surface 402 may be about 1 inch from side 206 of structure, yet in other embodiments, it may be more distant. In certain embodiments, surface 403 may be positioned substantially perpendicular (i.e., 90 degrees+/−5 degrees) with respect to surface 402. Surfaces 402, 403 may intersect or otherwise meet to form substantially a right angle (i.e., +/−5 degrees).

Surface 402 may be configured to mount one or more supplies that are often utilized in the repair or upgrade of components within the structure 200. In one embodiment, one or more rolls of cabling 408a-408c may be provided. By mounting cables within the structure 200, technicians are more likely to comply with using consistent gauge wires for repairs and upgrades. Further, various collections of cabling may be marked for easier identification. For example, in one embodiment, one or more colors may be used to identify a specific gauge or type of cable. In one embodiment, roll 408a may consist of excess power cabling, roll 408b may consist of excess signaling cabling, such as fiber cabling, and roll 408c may include additional power cabling, signaling cable or combinations thereof. Although the term “roll” has been used to designate one type of collection of cabling, those skilled in the art will readily appreciate that this is not a requirement. Further, some embodiments may have greater or fewer than three collections of cabling. In certain embodiments, the collection of rolls 408 may be positioned substantially along a horizontal axis such as shown in FIG. 4.

Components 410a, 410b may also be provided on surface 402. For example, in one embodiment, components may include one or more modems which may be centered on surface 402 with respect to the width (distance between edge 404 and edge 406) of the surface. In one embodiment, components may be centered on surface 402 with respect to the depth of the structure, such as structure 200, that surface is mounted within.

Surface 403 may be located parallel with a rear portion of a structure, such as back 210 of structure 200. Therefore, in such an arrangement, surface 402 may have a left-most edge 412 and a right-most edge 414. It may be located proximate to back 210, such as within an inch, however, in other embodiments, surface 403 may be more distant.

Surface 403 may have one or more voids or orifices for passage of cables through surface 403. For example, orifices 415, 416 may be aligned along a horizontal axis, such as shown in FIG. 4. Orifices may be positioned to pass cables through either direction. For example, a cable may pass through orifice 415 along a z-axis, such that the cable would be travelling away from the viewer of FIG. 4 and then bend and pass through orifice 416 is the opposite direction, such that it would generally face the viewer of FIG. 4. This may be especially advantageous for mounting cables having large bending radiuses, such as to bus bar 300, which is not required to be mounted or secured to surface 403.

Surface 403 may further be configured to position a surge protector 418, such as, for example, a DC surge protector. In one embodiment, surge protector 418 may be configured in an upper quadrant of surface 403. For example, in the illustrative embodiment of FIG. 4, surge protector 418 may be located in the upper left quadrant of surface 403.

Surface 403 may be configured to mount components on its lower half. For example, one or more transtectors, such as transtectors 420, 422 may be mountable to surface 403. As seen in FIG. 4, transtectors 420 and 422 may be proximate, such as within an inch, to bottom edge 424 of surface 403. Yet, in other embodiments, transtectors 420 and 422 may be positioned further from bottom edge 424. In certain implementations, transtectors 420, 422 may be at least 3 inches away from edges 412 and 414.

Surface 403 may be further configurable to mount additional peripherals, such as transtector 426 on the upper half of the surface. In certain embodiments, surface 403 may be configured such that transtector 426 (or any other component) is at least partially behind bus bar 300. For example, as seen in FIG. 4, at least about 25% of transtector 426 is blocked from the planar view by bus bar 300, which may not be mounted to surface 403.

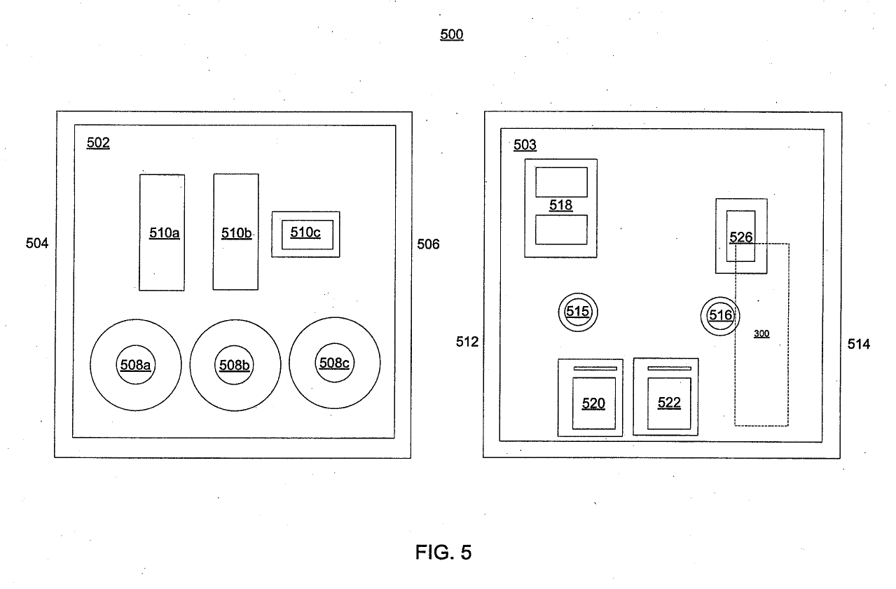

FIG. 5 shows a further illustrative orientation and configuration that may be implemented in accordance with various embodiments of the invention. Reference numerals provided in context of FIG. 4 have been consistently applied, when appropriate, to identify like components. For example, 400 corresponds to 500 and so forth. Therefore, no further explanation is warranted. Furthermore, although the above discussion utilized exemplary transtectors, modems, and rolls of cable as exemplary components and supplies, those skilled in the art with the benefit of this full disclosure will readily understand that other components may be configured or arranged as shown without departing from the scope of this disclosure.

Structure 200 may further include one or more component mounts. For example, rack mounts, such as rack mounts 222 may be mounted to one or more surfaces. Rack mounts 222 may be industry standard mounting devices. In one embodiment, mounts may be 19 inch mounting brackets.

Structure 200 may further include a front panel or door (not shown) to prevent environmental damage or theft of any components. In one embodiment, a panel or door may include a pocket or shelf, such as pocket 224 to contain documents, including wiring diagrams, instructions, user guides or other documents which may be useful.

We claim:

1. An apparatus comprising:
a structure having:
a top and a bottom;
a back vertically positioned between the top and the bottom;
a first side; and
a second side, wherein the first side and the second side substantially oppose each other along a vertical plane;
a substantially planar bus bar configured to be vertically positionable between the top and the bottom; and substantially parallel with the back of the housing such that an upper end of the bus bar is positioned above a lower end of the bus bar, the bus bar comprising:
a first plurality of orifices located on the upper end, each having a first perimeter; and
a second plurality of orifices located on the lower end, each having a second perimeter that is larger than the first perimeter;
wherein the bottom of the structure is configured to receive at least one power cable permitting the cable to traverse above a first orifice of the first plurality of orifices and bend along a bending radius to traverse substantially along a downward vertical direction to place the cable in direct operative connection with a first orifice of the second orifices.

2. The apparatus of claim 1, wherein the first cable is a suppressor cable.

3. The apparatus of claim 1, further comprising:
a first substantially planar non-conductive surface configured to be secured to either side of the structure, thereby being substantially parallel to a corresponding portion of the respective side of the housing and substantially perpendicular to the back.

4. The apparatus of claim 1, wherein the first non-conductive surface further comprises a mounting mechanism configured to mount the bus bar.

5. Wherein the bus bar is mounted about 2 inches from the respective side and about 10 inches from the back of the structure.

6. The apparatus of claim 3, further comprising:
a second substantially planar non-conductive surface configured to be substantially parallel to and proximate to a corresponding portion of the back surface of the structure.

7. The apparatus of claim 1, wherein the bottom comprises a vertically arranged cable reception orifice configured to receive the at least one power cable.

8. The apparatus of claim 6, wherein the first and the second non-conductive surfaces comprise a material selected from the group consisting of: wood, rubber, plastic, and combinations thereof.

9. The apparatus of claim 8, wherein the first surface is positioned within the structure such that a first edge of the first surface is proximate to the front of the structure and an opposing second edge of the first structure is proximate to the back of the structure; and
wherein the second surface is positioned substantially perpendicular with respect to first surface.

10. The apparatus of claim 9, wherein the first and the second surfaces are joined together to form substantially a right angle.

11. A bus bar comprising:
a planar surface having a first end and a second end providing a length of about 18 inches;
wherein the first end comprises a first plurality of substantially circular orifices having a first diameter of about 0.75 inches;
wherein the second end comprises a second plurality and a third plurality of substantially circular orifices; in which the diameter of the second and third plurality of orifices is less than 0.5 inches.

12. The bus bar of claim 11, wherein the diameter of the second plurality of orifices is about ⅜ inches.

13. The bus bar of claim 11, wherein the diameter of the third plurality of orifices is about 0.25 inches.

14. The bus bar of claim 13, wherein the location of at least a portion of the first plurality of orifices are positioned within 1 inch of a location furthest from the second end.

15. The bus bar of claim 10, wherein the first end of the bus bar is devoid of any second or third plurality of orifices.
